(19) United States
(12) Patent Application Publication
(10) Pub. No.: US 2006/0108225 A1
(43) Pub. Date: May 25, 2006

(54) High conductivity sieving matrices for high resolution biomolecule separations

(76) Inventor: Stephen Carson, Winthrop, MA (US)

Correspondence Address: NASHOBA LEGAL, P.O. BOX 4004, WESTFORD, MA, 01886, US

(21) Appl. No.: 11/273,835

(22) Filed: Nov. 15, 2005

Related U.S. Application Data
(60) Provisional application No. 60/629,778, filed on Nov. 19, 2004.

(51) Int. Cl. B01D 57/02; G01N 27/447

(52) U.S. Cl. 204/455; 204/605

(57) ABSTRACT

This invention relates to methods and compositions for the separation of biomolecules using capillary electrophoresis with high conductivity sieving matrices. These methods and compositions are particularly useful to increase readlength and migrational speed.

### RELATED APPLICATION

This application claims the benefit of Provisional Application U.S. Application No. 60/629,778, filed Nov. 19, 2004, the entire teachings of which are incorporated herein by reference.

### FIELD OF THE INVENTION

This invention relates generally to capillary electrophoresis of biomolecules such as DNA, RNA and proteins, and more particularly, to an improved method of separation of fragments in a sieving medium by improved stacking and reducing the effects of aligned bias reptation and the interaction of biomolecules with their surroundings.

### BACKGROUND OF THE INVENTION

Electrophoresis is a technique used for the separation and analysis of charged molecules or fragments of such molecules. Most frequently, electrophoretic methods are used to analyze the units comprising the building blocks of biopolymers (or biomolecules) of DNA (double or single-stranded), RNA, and amino acid polymers such as proteins or polypeptides.

To apply this technique, one or more samples of biomolecules are loaded onto a separation medium and a voltage is applied across the medium. During electrophoresis, smaller fragments of a molecule move faster through the medium than larger fragments, separating the sample into its many components. If the medium is a gel or matrix, a sieving effect is introduced into the process, which helps to separate such molecules according to size or charge.

Many molecular separations are done by capillary, micro-channel, or ultra-thin slab gel electrophoresis (hereinafter capillary electrophoresis), wherein the voltage is applied across a capillary type that contains a separation media. Typically, the separation medium is a crosslinked gel, a polymer solution or other flowable media or a fixed array which forms a mesh, such as a post field array. As the voltage is applied, the biomolecules differentially migrate to a detector. Factors that affect the rate of migration include the conformation, weight and charge on the molecules, the nature and properties of the separation environment, and the conditions under which the process is performed. All of these factors affect the resolution of the samples as they are processed and the final results.

Today, much of the capillary gel electrophoresis process is automated. However, the procedure is still deficient in the resolution of large pieces or fragments of biomolecules. There is a need to improve this process to increase the results of analysis of biomolecule samples.

### SUMMARY OF THE INVENTION

It is an object of this invention to provide separation media with improved separation capabilities at temperatures over 25° C. It is also an object of the present invention to provide a method of increasing the resolution of a capillary electrophoretic separation of biomolecules using a sieving medium by increasing the separation selectivity [separation between peaks or bands] by reducing aligned bias reptation.

It is another object of the invention to increase the signal to noise ratio by more effective stacking of the injected sample, while not increasing the interaction of the analyte with its surrounding environment during the separation process.

It is another object of the invention to improve the efficiency [narrower peak width] of the separation in a sieving medium by reducing a biomolecules interaction with itself or its surrounding environment.

These and other objects of the invention are achieved by creating an ionic cloud around the charged biomolecule, which is undergoing the electrophoresis process in a sieving matrix solution. The cloud should have a thickness and ionic concentration to reduce aligned biased reptation to as low a level as possible while at the same time producing an acceptable separation time. As part of this invention, higher ionic concentrations [conductivity] than have previously been used in capillary electrophoresis have been found to produce much higher resolution for larger fragments and has increased signal to noise ratio for all fragment sizes. As an unexpected benefit, higher conductivity also produces a faster sample running time and therefore, has the benefit of higher throughput and reduced expense.

More specifically, these and other objects of the invention are achieved by using buffer solutions that are much more conductive than presently used in DNA sequencing apparatus. Total conductivities of approximately greater than 1.3 mS (milliSiemens/cm) at temperatures of at least 25° C. begins to produce an ionic concentration where improved resolution and signal to noise is observed. Continued improvement in the speed of migration of large fragments and their resolution can be obtained by increasing the concentration further, until a maximum is shown as described in FIGS. 1 and 2.

Higher signal size is approximately proportional to sieving matrix's total conductivity. By increasing sieving matrix's total conductivity, more analyte can be loaded without widening the injection plug. In addition, the higher conductivity matrix allows higher concentrations of analyte to exist in the band without diffusing. The injection time and voltage can be adjusted to give an optimum plug size and signal for the buffer conductivity and analyte concentration being used.

In a preferred embodiment, a combination of urea with high conductivity buffer with a total conductivity of between 3-4 mS used during a separation process by capillary electrophoresis running at a temperature of 44° C. resulted in improved readlength and speed of separation.

### BRIEF DESCRIPTION OF THE DRAWINGS

FIG. 1 is a graph displaying the readlength results shown in the Table I as an outcome of increasing capillary conductivity.

FIG. 2 is a graph depicting migration speed as a result of increasing capillary conductance.

The foregoing and other objects, features and advantages of the invention will be apparent from the following more particular description of preferred embodiments of the invention, as illustrated in the accompanying drawing in which like reference characters refer to the same parts throughout the different views. The drawings are not necessarily to scale, emphasis instead being placed upon illustrating the principles of the invention.

### DETAILED DESCRIPTION OF THE INVENTION

### DEFINITIONS

Electrophoresis is a process for separating charged molecules. An elongated volume, such as a capillary or a micro-channel, is filled with a buffer solution and a sieving medium. The charged DNA, RNA, polypeptide or protein molecules are placed in one end of the volume and a voltage is applied to the ends of the capillary. The negatively-charged molecules are pulled through the volume towards the positive electrode. As they pass through the volume, the molecules have to push their way through the sieving medium. The larger molecules are retarded relative to the smaller ones, which pass through more quickly. This process produces a separation where the molecules of like size can be detected at a window in the capillary sequentially.

Running buffer is defined as the buffer in the anode and cathode reservoir not the buffer in the capillary sieving medium.

A Buffer System is composed of an organic or aqueous solvent such as water and an acid base combination such as but not limited to Tris and TAPS, which stabilizes the pH of the system and other conductive ions such as but not limited to EDTA or KCL.

Total Conductivity is a measure of the conductivity of the coating on the interior capillary wall and the entire polymer solution, which includes the buffer system, polymer, denaturants, detergents and any other additive to the polymer solution that is in the volume undergoing electrophoresis. Conductivity is measured in milli-siemens/centimeter which is represented by the abbreviation mS.

Electro-kinetic injection is a technique that is used to insert charged analyte ions into a capillary for analysis. The normal configuration is for one end of a capillary to be submerged in a vial that contains the negatively-charged analyte in a solution and that end to be connected to the negative end of a high voltage supply. The other end of the capillary is connected to the positive end of the supply. A current passes through the analyte vial and the capillary with some of the ionic charges being the analyte molecules when the voltage is turned on. If the analyte is positive, the polarity of the high voltage power supply is to be reversed.

Electrosmotic flow [EOF] is a phenomenon, which occurs at the interior interface between a glass/silica [or other materials] capillary and an ionic solution. Glass has a charged layer of silanols on its surface. These silanol groups become fully ionized when the pH of the ionic solution is above about pH 8.5. The ions in the buffer form an opposite charged layer, which builds up on the surface of the glass. When an electrical potential is applied to the buffer as occurs in electrophoresis, the negative ionic layer on the surface of the glass starts to move in the direction of the positive electrode. The movement of the charges carries along some of the buffer with it. After awhile this charge flow starts to act as a pump, which pushes the buffer/gel out of the capillary. Maximum EOF occurs when the charge layer is greatest on the wall of the capillary; this occurs at a pH above 8.5 but can be reduced by increasing the ionic strength of the buffer. This buffer flow can destroy any DNA separation that would be occurring in the capillary and therefore needs to be stopped by some means. One means is by coating the interior wall of the capillary either with a covalently or dynamically-adhered polymer coating. These coatings can reduce EOF to approximately 0.5% of its uncoated value but not to zero [23, 24]. The coatings also reduce analyte interaction with the walls of the capillary. Over time, these coatings degrade and the amount of EOF increases in magnitude until it noticeably degrades the separations resolution.

Dynamic-coating polymers which reduce electrosmotic flow [EOF] are described in U.S. Pat. Nos. 6,355,709 and 6,410,668 and have improved EOF suppression characteristics at higher buffer ionic strength [18]. Their ability to coat effectively is pH sensitive. These polymers along with denaturants and high conductivity buffers can be used for electrophoretic separations of biomolecules.

A Denaturant prevents a biomolecule from adhering to itself and developing secondary structure. Denaturants such as urea, formide, 2-pyrodionone and DMSO [Dimethysulfoxide] are some examples of chemicals that prevent renaturation of biomolecules. High temperature and pH are means that can also be used to prevent renaturation.

The term capillary applies to any material which is in the shape of an elongated hollow cylinder-like shape with an inside dimension of less than 120 μm. Micro-channels can be considered capillaries. Micro-channel devices have elongated channels, which are etched into surfaces to form three-dimensional structures. These channels have dimensions less than 120 μm over most of their length and have a large surface area to cross sectional area ratio. Ultra thin slab gels are two parallel planes of glass/silica that have a space between them of 100 μm or less. A sieving medium is place between the two plates in the same fashion as normal thickness slab gels. Micro-channel and ultra thin slab gels are considered capillaries due to their large heat removal properties to cross sectional area ratio.

Biomolecules include proteins, polypeptides and nucleic acids, particularly DNA or RNA. Biomolecules with a total length greater than a 300 base length of DNA can be noticeably affected by aligned biased reptation in a sieving medium and benefit from a higher concentration ionic environment.

A sieving medium such as a gel has a stable structure with various mesh or pores sizes. Polymer solutions consisting of a single polymer or a mixture of one or more types of polymers form a sieving medium whose pore size changes with time [e.g. linear polyacrylamide, hydrolyzed epoxy poly dimethylacrylamide, poly dimethylacrylamide or branched, star polymers as described in U.S. Pat. Nos. 6,716,948, 5,567,292 or 6,410,668]. Tiny post field arrays with a post separation of the order less than 1500 angstroms may prove to be a better way of supplying a sieving mesh in the future. Sieving media can be replaceable in the capillary or non-replaceable. Whatever the choice of sieving media the buffer is to be uniformly distributed throughout the sieving medium.

Pore/Mesh size is the open aperture framed by intertwined or cross-linked polymers in a solution or gel [25].

Aligned bias reptation or oriented bias reptation [19, 20] is a phenomenon that occurs when a biomolecule like DNA is stretched out during an electrophoretic separation by the forces of the electric field and the physical constraints of a sieving matrix. The DNA takes on a rod-like shape and aligns itself with the electric field. Under these conditions, different lengths of DNA migrate at the same speed.

Joule heating is produced by the heat generated from the electricity running through the polymer solution during electrophoresis. The amount of heat in watts can be calculated by multiplying the voltage times the current. For a single capillary running with 7000 volts applied across each end and a current of 10 microamperes, the amount of heat generated is 0.07 watts. This heat will escape the interior of the capillary by conduction. In the process, it forms a slight thermal gradient that is hottest in the center and coolest on the periphery. If the gradient is too large it will effect the migration of the analyte as it is separating.

Readlength is the total number of DNA bases read during an electrophoretic separation. The base caller software Cimmaron 1.53 [Salt Lake City, Utah 84101], supplied with the MegaBACE 1000 has a built in algorithm, which determines when a base has been satisfactorily separated and uses this to determine the readlength. Other base callers such as Phil Green's Phred [University of Washington, WA] use a different criteria and may produce different readlength numbers. The results of the experiments described herein utilized the Cimmaron base caller, which is used as a measuring stick to demonstrate the improved results of a high conductivity separation.

DNA sequence information is critical to understanding genetic variations, which can influence disease and genetic interactions, as well as drug efficacy. As such, automated sequencers using capillary electrophoresis play a vital role in the drug discovery process. The use of sequencers in drug discovery has expanded beyond simply decoding genomes to mutation detection and to understanding cellular messages in the hopes of developing novel drug compounds. Further, automated sequencers can be used to analyze the unit structure of other biomolecules such as RNA, proteins and polypeptides.

Gel/polymer solutions electrophoresis is a powerful method of separating large biomolecules, such as proteins, deoxyribonucleic acids (DNA), and ribonucleic acids (RNA). Gel/polymer electrophoretic separations of proteins and nucleic acids can be performed in the polymer solution under denaturing conditions. For example, proteins can be dissolved in a detergent solution, e.g., sodium dodecyl sulfate (SDS). The charge and bulk of the protein-SDS complex are roughly proportional to the mass of the native protein. Displacements of a protein within a sieving matrix can thereby be related to molecular size on a basis of the size and charge on the molecule. In the case of nucleic acids, which have roughly the same charge density, displacement in the sieving matrix is more directly related to molecular size.

Capillary electrophoresis continues to be the method of choice to sequence DNA on a large scale. However, extending the readlength of this process has been incrementally slow. The most significant performance limitation/operational problem that faces researchers using automated DNA sequencing equipment is that the average readlength is too short.

Over the last ten years perhaps a 200 bases increase in readlength has been achieved. At present, a sequencing run using a MegaBACE™ 1000 [GE/Amersham Bioscience, Piscataway, N.J. 08855-1327] machine averages 750 bases per capillary with a dye terminator standard. An Applied Biosystem 3730 machine (Foster City, Calif. 94404) reads approximately 100 additional bases under similar conditions. The longest readlength reported in the literature has been 1300 bases in 2 hours [10]. All readlengths however need to be compared by the same standards in a manner similar to that used by Liguo Song & Ben Chu [12] when their 800 base results were put in perspective by using a 0.5 resolution criteria. The 1300 base run with 2.5% LPA and at 70° C. [10, 21, page 110] is only an 830 base run when the data is reanalyzed using the 0.5 resolution standard. Although better base-callers and runs at higher temperatures have produced some improvements, there is a need to improve the separation resolution and signal to noise ratio of fragments in the 700-1500 base range, so that longer readlengths may be achieved in commercial instruments without excessive running time.

The currently available commercial DNA sequencing reaction parameters produce a distribution of fluorescently-labeled fragments that are heavily weighted to smaller length fragments. Normal electro-kinetic injection produces decreasing signal for increasing fragment size. One manufacturer, Applied Biosystems, has changed their DNA sequencing reaction to try to increase the yield of larger fragments, but has had minor success.

Another strategy attempted has been to inject a larger sample. However, many publications have shown that there is a limit to the amount of sample that can be injected before the injection plug becomes too wide. To prevent this problem the technique of stacking is used. However, attempts to improve stacking by increasing total conductivity have not worked and, in some cases, have resulted in a large loss of resolution and signal to noise ratio [21].

The benefits of high ionic concentration are mentioned in several journal articles [1, 2, 3, 4, 11, and 13] but few attempts have been made to apply this technique to capillary gel electrophoresis with large fragments, and those few have had no success at normal operating temperatures. High ionic strength increases the maximum analyte concentration in the band, decreases band diffusion, decreases Electro-Osmotic-Flow [EOF], and decreases interactions between the wall and the DNA, and improves overall resolution in free solution and agarose.

In this invention, the benefits of using high ionic concentration (high conductivity) are described. Not only is readlength increased for large fragments of biomolecules, the speed of the process is improved as well. In addition, these results show that the biomolecule separation process can be carried out at more optimal separation temperatures (greater than 25° C.).

The results presented here were done using Amersham's coating [U.S. Pat. No. 6,074,542], which is likely a [Si—C—Si] covalently bonded acryloydiethanolamine polymer, EDTA levels were less than 2.5 mM for all buffer systems and the separation temperature was 44° C. High levels of EDTA [11 mM] have been shown to be highly deleterious to separation quality during this evaluation and the levels of this component should probably be kept low.

The compositions and methods of this invention produce increased readlengths into the 1200+ base range by improving signal size and resolution. The improved readlengths resulted from increasing the total ion concentration/conductivity of the buffer system in the sieving matrix solution. Another surprising benefit was that the migrational time of the larger fragments were decreased at a higher conductivities range.

In these analyses, a plate of 50 samples was made using a Big Dye® terminator v1.1 kit [Applied Biosystem. Foster City, Calif. 94404] with pGEM DNA standard using ethanol precipitation and injecting from water. A Cimarron 1.53 base-caller [Salt Lake City, Utah 84101] produced readlengths of 1220 bases for 50 samples with a one-lane maximum of 1429 bases. This was done using a standard MegaBACE™ 1000 [GE/Amersham Bioscience, Piscataway, N.J. 08855-1327], run at 44° C. at 6.2 kv with a run time of 250 minutes. The same machine using the Amersham™ matrix and the same samples produced a plate average of only about 800 bases in a run time of 180 minutes. The calling accuracy was checked manually for one of the lanes with the known sequence and it was found to be 99% accurate up to 1050 bases. The base-caller had called 1160 bases with 97% accuracy for that capillary. The resolution measured at base 1135 was 0.50. The migration times of base 830 and 1135 were 165 and 235 minutes respectively. The above experiment was repeated for a variety of pH and buffer system concentrations using TrisTAPS, TrisTAPS EDTA and Tris Borate. Similar results were found as described in the Table I infra.

The following abbreviations used in the description of the invention are as follows:

TAPS is Sigma Aldrich cat# T9659, Chemical name (N-tris[Hydroxymethyl]-3-aminopropanesulfonicacid; [2-Hydroxy-1,1-bis(hydroxymethyl)ethyl]amino)-1-propanesulfonic acid).

Tris is Fisher cat# BP-152, Chemical name is Tris(hydroxymethyl)aminomethane.

EDTA is Sigma-Aldrich Cat# E5134, Chemical name is Ethylenediamine Tetraacetic Acid, Disodium Salt dehydrate.

### ABBREVIATIONS

TT=Tris TAPS

TTE=Tris TAPS EDTA

TB=Tris Borate

TBE=Tris Borate EDTA

E=EDTA

TAE=Tris Acetate

Although pH or concentration for TB was not optimized [Table I], the result shows that increasing conductivity has a big effect on the separation of larger fragments, and that it is not limited to one buffer system. Using 2.5% polymer, 6.4 M urea, and TB buffer [Tris 397 mM boric acid 375 mM], pH 8.3, total conductivity 1.31 mS, the average number of calls for 12 samples was 1059. The TB buffer system at this pH does not have conductivity as high as TT or TTE and hence, its ability to stack is not as effective. In addition, it has slightly less effect on the resolution of the larger fragments. The TB buffer system produced the same readlength as the Tris=80 mM, TAPS=240 mM buffer system which had the same conductivity.

The buffer chosen may vary depending on the application. Any buffer used should have sufficient buffering capacity for the quantity of electrolysis products produced during an electrophoretic separation. Increased electrical current proportionally increases the demand on the buffer system to maintain pH. The type of buffer and its pH should be chosen with the usual concerns towards compatibility with the detergent, capillary coating, denaturant, sieving matrix and the desired charge to be imparted to the biomolecule. A buffer system for separation of biomolecules during capillary electrophoresis can consist of components producing a total conductivity greater than 1.6 mS measured at a temperature of at least 25° C. during separation in the capillary. Temperatures during separations can range from 25° C. to 70° C. or higher if urea is not used. Urea starts to decompose at 70° C. but DMSO and other denaturants do not decompose and separations have been done up to 95° C. using DMSO.

Typically, a buffer system can comprise any of the following components: Tris TAPS, Tris Borate, Tris Acetate, TAPS NaOH, NaOH and Boric Acid, Tris-H3PO4,Tris Bis TAPS, Tris Bis TAPSO, Tris formic acid, Tris pentonic acid, Tris propionic acid, Tris TAPS Histidine, N-[tris-(hydroxymethyl)methyl]glycine, N-2-hydroxyethylpiperazine-N′-2-ethane sulfonic acid, N,N-bis(2-hydroxymethyl)-2-aminoethane sulfonic acid, 3-(4-Morpholino)propane sulfonic acid, N-tris(hydroxymethyl)methyl-2-aminoethane sulfonic acid, Tris-Ches, MES—Na, AMPO-cacodylic acid (CACO) and a chelator such as EDTA or equivalent. This list is not meant to be exhaustive, however, and one skilled in the art can combine these and other buffer components to produce a high conductivity buffer for capillary electrophoresis.

The total conductivity of the polymer solution is also affected by denaturants such as urea and or 2-pyrrolidone. A 6 M [38%] urea solution or a 10% 2-pyrrolidone solution reduces conductivity approximately 25%. Separations with 6 M urea and 10% 2-pyrrolidone and with Tris=160 mM, TAPS=140 mM, EDTA=1.6 mM] concentrations were tested. This produced readlengths of over 1000 bases. The use of 6 M urea and 10% 2-pyrrolidone decreased the separation speed [15] of all fragments but larger fragments >700 had a higher mobility than expected. A higher running voltage of 165 volts/cm was required to get an overall separation time equivalent to using only 6.4 M urea. These may be acceptable tradeoffs for separations, which require more uniform migrational profiles [15].

The following group of denaturants are used in the field and can be applied to the disclosed systems of this invention: urea, dimethysulfoxide, betaine, formide, 2-pyrrolidinone, 1-methyl-2-pyrrolidinone, N-alkyl pyrrolidones, N-ethyl-pyrrolidone, N-hydroxyethyl pyrrolidone, and N-cyclohexylpyrrolidone, delta.-valerolactar, .epsilon.-caprolactam, and/or N-methyl-.epsilon.-caprolactam. This list is not meant to be exhaustive and a skilled artisan can recognize that other compounds useful as denaturants can be used to substitute in these systems. Further, mixtures of these compounds can also be part of these formulations.

TABLE I

| | | | Capillary | | |
|---|---|---|---|---|---|
| Buffer Formula | Conductivity | | Conductivity | Cimarron 1.53 | |
| In capillary | Meter 22° C. | pH | 44° C. | Base Call/% correct | Inject# |
| 150 mMTT, E = 0 | 1.64 mS | 8.4 | 3.17 mS | 1207/95.9 | 3^{rd} |
| 250 mMTT, E = 2 mM | 2.48 mS | 8.3 | 3.89 mS | 1143/95.57 | 6^{th} |
| 150 mMTT, E = 1.5 mM | 1.60 mS | 8.3 | 2.78 mS | 1172/95.8 | 3^{rd} |
| 150 mMTT, E = 1.5 mM | | 8.3 | | 1053/95.7 | run at 5.5 kV |
| 150 mMTT, E = 2.0 mM | | 8.3 | | 1025/96.3 | run at 5.5 kV |
| 200 mMTrisTaps150 mM, E = 0 | 1.88 mS | 8.7 | 3.48 mS | 1220/ | 1^{st} |
| 300 mMTrisTaps225 mM, E = 2 | 2.58 mS | 8.7 | 4.23 mS | 1056/94 | 7^{th} |
| 33 mMTrisTaps110 mM, E = 1.8 | .92 mS | 7.8 | 1.37 mS | 825/96.2 | 7^{th} |
| 80 mMTrisTaps240 mM, E = 0 | 1.30 mS | 8.0 | 2.21 mS | 1059/95.77 | 6^{th} |
| 397 mMTris, Borate375 mM, E = 0 | 1.31 mS | 8.3 | 2.17 mS | 1059/96.0 | 5^{th} |

In the Table, the sample conditions for preparing sequencing runs were as follows: injection 2 kv for ˜45 seconds, pGem[R]-3Zf[+] vector, pUC/M13 primer reverse, ABI Big Dye Terminator v1.1, 70 cycles, ethanol precipitation from pooled sample, injection from water, and multiple injections were done from the same sample plate. The polymer solution composition for all runs contained approximately 2.5% linear polyacrylamide, molecular weight of about 10 million, and 6.4 moles of urea. The polymer solutions were heated to 60° C. for 80 minutes and vacuumed prior to use. The buffer concentration is varied according to Table I.

The capillaries were 75 μm i.d. and about 60 cm overall length, with a separation length of about 40 cm. The capillary conductivity was higher than meter conductivity for two reasons; the polymer solution was heated for 80 minutes at 60° C. [this temperature breaks down polymer solution components to produce more ions] and the capillary temperature of 44° C. increases overall conductivity.

The running conditions for most of the runs was: 44° C., running voltage 6.2 kv-6.5 kv, pre run 7 kv, 12 minutes, and the running buffer in anode and cathode reservoirs was TTE, ph7.8 [Tris=90 mM, TAPS=300 mM and EDTA=3 mM]. The voltage for two of the runs was 5.5 kv, where noted in the Table.

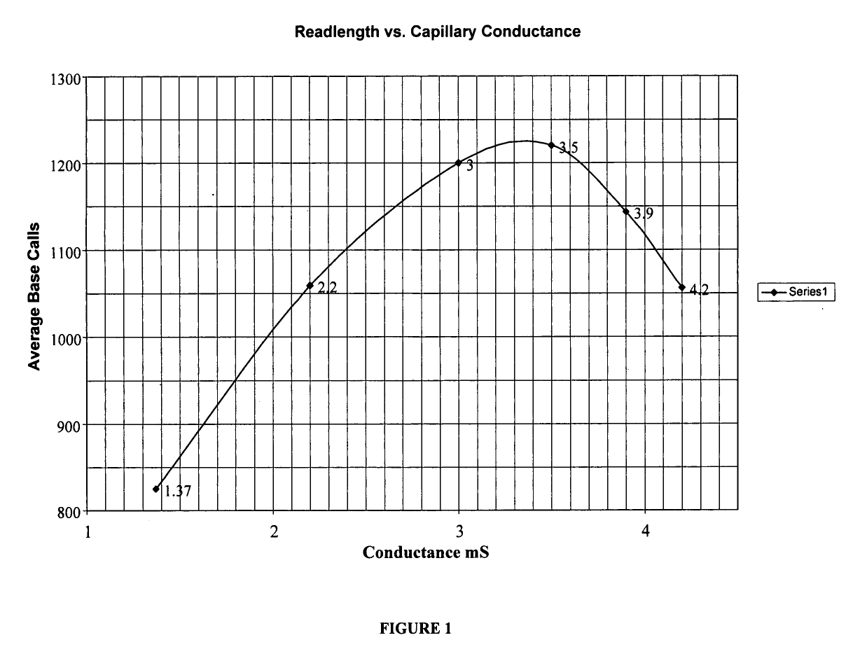

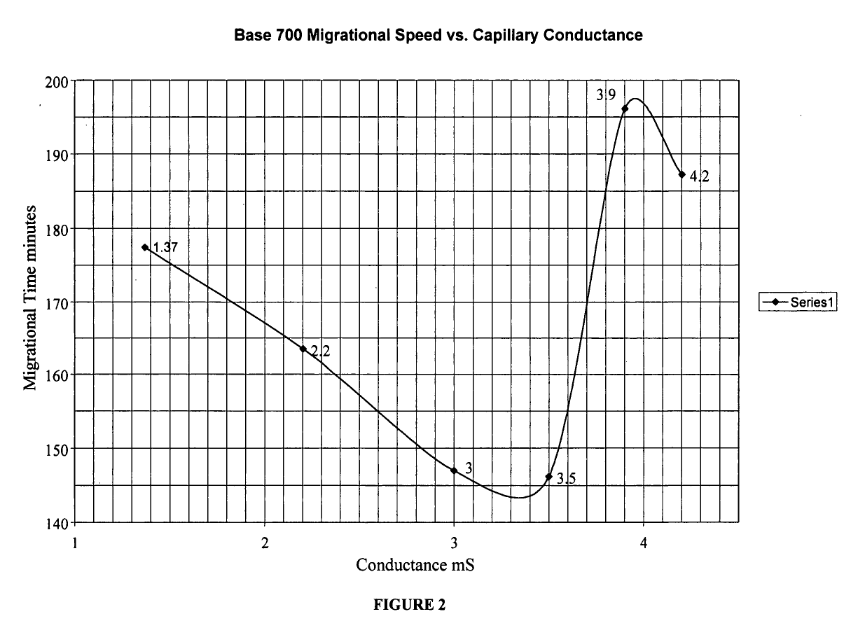

The data from Table I was plotted and is presented in FIG. 1. It shows that a maximum readlength occurs in the conductance range 3.0-3.5 mS for TTE polymer solutions. FIG. 2 was made using the same raw experimental data on which FIG. 1 is based. FIG. 2 is a comparison between the migrational speed of base 700 and the conductance of the capillary tube.

The following advantages have been observed for separations of high conductivity versus normal buffer conductivity. The term peak refers to a graphical representation of concentration versus migrational time for fragments that have undergone an electrophoretic separation. Higher selectivity means wider spacing between the peaks and higher efficiency means narrower peak width in a separation. Resolution is the ability to determine if there are one or more peaks for fragments with similar migrational times. The higher the number the easier it is to determine the number of peaks. Resolution is proportional to [selectivity]×[efficiency].

TABLE II

| | Conduc- | Resolu- | Selec- | Effi- | |
|---|---|---|---|---|---|
| Fragment Size | tivity | tion | tivity | ciency | Mobility |
| Less than 200 b | + | − | −− | + | −− |
| More than 700 b | + | ++ | ++ | + | − or + |

Table II shows that the drop in resolution for small fragments is caused by a large decline in selectivity only. Large fragment resolution improved for efficiency and selectivity reasons with selectivity being the dominant factor. The migration time of base 700 is the fastest at a conductance of 3-3.5 mS, which is the same conductance range where the maximum readlengths occurred as seen in FIG. 1.

The result from FIG. 2 seems to be counterintuitive; the increasing concentration of ions would be expected to neutralize the overall charge on the DNA and slow its migration. For small fragments, this is exactly the case in these conductance ranges but not for fragments ˜400-1130 or larger. They follow the pattern of FIG. 2, which shows an increase of migration speed within a region of increasing total buffer system conductivity.

The largest fragments at the end of a separation sometimes migrate in an unresolved group. This group appears at the end of a sequencing trace as a hump. The hump becomes bigger and occurs sooner if the running voltage, or matrix concentration, is raised. The hump is caused by aligned biased reptation. If fragments of different size migrate at the same speed, then selectivity is zero and a hump is formed. It has been observed that with high conductivity buffers, these humps do not appear as usual. This demonstrates that the high conductivity buffer has improved the selectivity of very large fragments.

The selected buffer systems can be used with a variety of sieving media and denaturants. Sieving solutions with the following total conductivities of 1.0 mS, 2.0 mS, 3.0 mS and 4.0 mS can be prepared and tested at low voltage [100 volts/cm]. If a high voltage were chosen, [e.g. 400 volts/cm] aligned bias reptation would interfere with the detection of improved readlength; therefore, 100 volts/cm has been chosen as a starting point. The preferred voltage will vary with temperature, concentration and the type of sieving media. It also will be affected by the amount and type of denaturant. The art describes the effects of voltage on performance with various sieving media and denaturants. The 100 volt/cm setting can be used to determine a reasonable conductivity range. This provides a starting point to optimize the other variables as would normally be done if a new separation media were being applied to an application. After plotting the migration, time versus conductivity and readlength versus fragment size for different conductivities, a decision can be made as to the optimum conductivity. A further optimization can be made by varying the pH of the selected buffer conductivity within the range that is considered compatible. Certain buffer solutions, such as Tris Borate EDTA [TBE], do not produce optimal results, probably because TBE has shown to interact unfavorably with PVA-coated capillaries. Also overall separation rates are slower.

Using monovalent ions as the conductive ions in the sieving solution reduces the chances of bridging and interaction. The conductive ions should be predominately buffer ions with monovalent salts or chelators at low levels. Chelators like EDTA [ethylenediaminetetraacetic acid] should be kept at low levels 0-3 mM to reduce the chances of interaction. Additional ions from the decomposition of urea may be added by heating the entire sieving medium prior to use to 60° C. for 80 minutes or a higher temperature for a shorter period.

It has been observed that having EDTA in the cathode and anode buffer reservoirs with Tris/TAPS reduces current blockages. It works best when the polymer solution is in the pH range 8.4-8.8 and the running buffer is approximately 7.8. Having a differential between the concentration of EDTA in the running buffer and the amount of EDTA in the matrix in the capillary is preferred. Having no EDTA in the matrix and 3 mM in the run buffer gradually increases the matrix's EDTA concentration over the course of a run. The stability of the current in a capillary is very important to the quality, speed and success of the separation. At times current blockage occurs at the injection end of the capillary, either from template DNA, gas bubble formation or a depletion zone [8, 9, and 5]. This can slow the separation or completely stop it. If only TrisTAPS is used in the running buffer, a blockage will develop in the capillary due to the low transference number of TAPS. Therefore, EDTA should be added. For TrisBorate buffer the borate ion has a positive transference number [8, 9, 5] so EDTA is not required. Separations with and without EDTA in the running buffer were carried out for TrisBorate gels with no noticeable difference in readlengths. EDTA is not necessarily the only ion that could maintain current stability. EGTA, DTPA, TTHA and CDTA are chelators that may have similar properties. Any ion that has a positive transference number, and migrates at approximately the speed of EDTA, can be used.

The quantity and type of denaturants will affect the dielectric constant and conductivity of the sieving solution. This will have an effect on the ionic cloud surrounding the biomolecules and hence, migration time. Therefore, the original optimization should contain the type and concentration of the desired denaturant or detergents without substitution. If a substitution is made a re-optimization will be required for maximum performance.

Increasing the conductivity of the buffer increases the Joule heating but this poses no problem due to the extra heat dissipating capacity of the capillaries. The reason why many researchers do not increase the conductivity of the buffer is due to a long-standing concern that Joule heating will increase to detrimental levels in the polymer [6]. This was a huge factor for slab gels [7, 4, 14]. However, it is not a factor for capillaries because of their small cross-sectional areas and their large conductive and radiating surface areas. The buffer concentrations used in capillaries today are the same concentration as used in slab gel instruments [6, 7, 4]. The extra heat dissipating characteristics of capillaries were initially used to run separations at higher voltages. The assumed benefits of higher running voltages are shorter run time and higher resolution. It turned out that larger fragments suffered from aligned biased reptation and band diffusion. Hence, both of these effects required the use of lower running voltage to get better resolution for large fragments [17]. The optimization of raising the operating temperature and the lowering of the gel concentration has produced shorter running times thus obviating this problem. Faster runs were achieved by higher temperature and lower % gel rather than using higher voltage. Normally, a 2-3% gel solution is used, although 5% gel solutions are possible. A range of gel solutions, 0.5-9% having an effective pore size of less than 1200 angstroms can be applied in this invention.

The choice of the diameter of the capillary can be affected by the conductivity of the buffer and the running voltage chosen. Joule heating gradients within a 75 μm I.D. capillary are not of major concern for running voltages less than 130 volts/cm and a total conductivity of 4.0 mS. If higher voltages and/or conductivity are to be used, a smaller diameter capillary can be used to reduce temperature gradient-caused diffusion. Other electrophoretic configurations such as micro-channels and ultra-thin slab gels are suitable for the application of this invention and are capable of dissipating the extra heat, therefore minimizing the thermal gradient created by using high buffer conductivities. Micro-channels and ultra-thin slabs with the proper geometry are essentially the equivalents of capillaries and separations in these devices can benefit from high conductivity buffers.

Self-coating polymers such as described in U.S. Pat. Nos. 6,355,709 and 6,410,668, which reduce EOF are also suitable for the application of the methods and compositions described herein. These polymers have improved coating characteristics at higher buffer ionic strength [18]. Their ability to coat effectively is pH sensitive. Examples of these and other useful coatings, without intending to be limited, are: polyacrylamide, acryloylaminoethoxyethanol, acryloylaminoethoxyethylglucose, poly-N-acryloylaminopropanol, hydroxymethylcellulose, dextran, acryloyldiethanolamine acrylamide, dimethylacrylamide, Nacryloylaminoethylethanol, N(acryloylaminoethoxy)ethyl-.beta.D.glycopyranoside. acryloyldiethanolamine, Poly(vinylpyrrolidone), hydroxyalkylcellulose, poly(ethylene glycolmethacrylate), and Poly(ethyleneoxide).

Using higher conductivity sieving solutions can reduce the resolution of the smaller fragments [<200 bases]. Increasing the concentration of the separation polymer and possibly changing the mix of molecular weights [10] that make up the polymer solution will improve resolution of smaller fragments.

The migrational speed of smaller fragments is decreased at higher conductivity with the effect being proportionally greater as the fragment size decreases. Labeled dye nucleotide molecules that have not been incorporated during a dye terminator Sanger sequencing reaction will not be removed by some sample clean up protocols such as ethanol precipitation. The DNA sample has a very high concentration of fluorescently labeled dye nucleotides, which are injected into the capillary along with the DNA sample. In a high conductivity sieving medium, the small dye nucleotide molecules migrates relatively slower than their size would indicate. This produces a co-migrating dye front with fragments that are 40 to 85 bases long, making it impossible to correctly identify the base sequence from approximately 1-85 bases. Removing these labeled dye nucleotides by some other method such as Clean SEQ, SPRI [Agencourt Bioscience, Beverly Mass. 01915] can further improve readlengths and is preferred using the methods and compositions of this invention. A similar change will improve primer reaction sample clean up; however, the kits sold by different manufactures for clean up will probably differ. Thus a means to remove dye nucleotides and template from the analyte can be employed prior to or during electrokinetic injection.

Thus, this invention provides a method to separate biomolecules using capillary electrophoresis by placing in a capillary, a composition having a sieving medium and total conductivity of greater than 1.6 mS measured at a temperature of at least 26° C., adding the biomolecules to the capillary, and carrying out the separation at a temperature between 25° C. and 95° C. Further, the total conductivity can be greater than 2 mS and even 3 mS. The buffer system can contain EDTA and is generally comprised of any of the following: Tris TAPS, Tris Borate, Tris Acetate, TAPS NaOH, NaOH and Boric Acid, Tris-H3PO4, Tris Bis TAPS, Tris Bis TAPSO, Tris formic acid, Tris pentonic acid, Tris propionic acid, Tris TAPS Histidine, N-[tris-(hydroxymethyl)methyl]glycine, N-2-hydroxyethylpiperazine-N′-2-ethane sulfonic acid, N,N-bis(2-hydroxymethyl)-2-aminoethane sulfonic acid, 3-(4-Morpholino)propane sulfonic acid, N-tris(hydroxymethyl)methyl-2-aminoethane sulfonic acid, Tris-Ches, MES—Na, and AMPO-cacodylic acid (CACO).

In general, a denaturant such as urea will be part of the composition. Other denaturants can also be used. Without intending to be limiting, the following can be used instead of urea: dimethysulfoxide, betaine, formide, 2-pyrrolidinone, 1-methyl-2-pyrrolidinone, N-alkyl pyrrolidones, N-ethyl-pyrrolidone, N-hydroxyethyl pyrrolidone, and N-cyclohexylpyrrolidone, .delta.-valerolactar, .epsilon.-caprolactam, N-methyl-.epsilon.-capro.lactam and mixtures thereof.

The method described can also be used where the capillary interior has a covalently attached coating. The coating on the capillary interior can be selected from any group of polymers, such as polyacrylamide, acryloylaminoethoxyethanol, acryloylaminoethoxyethylglucose, poly-N-acryloylaminopropanol, hydroxymethylcellulose, dextran, acryloyldiethanolamine acrylamide, dimethylacrylamide, Nacryloylaminoethylethanol, N(acryloylaminoethoxy)ethyl-.beta.D.glycopyranoside.acryloyldiethanolamine, Poly(vinylpyrrolidone), hydroxyalkylcellulose, poly(ethylene glycolmethacrylate), or Poly(ethyleneoxide). Other coatings known to suppress EOF can be used with the methods described herein.

Another method of this invention used to separate biomolecules by capillary electrophoresis in a covalently-coated capillary tube is carried out where the mixture in the capillary tube has a denaturing means and the total mixture of polymer, denaturant and buffer system combined will have an initial conductivity of greater than 1.3 mS, measured at 40° C. and at 100 volts/cm and the separation is conducted above 25° C. It is understood that the conductivity can be 2 mS and even higher than 3 mS.

A polymer mixture according to this invention for separation of biomolecules in a capillary during capillary electrophoresis can comprise: a 0.5-9% polymer solution having an effective pore size of less than 1200 angstroms. a buffer solution containing less than 4 mM EDTA; wherein the polymer mixture has a total conductivity greater than 1.4 mS at a temperature of at least 26° C. during separation in the capillary. The denaturant of this polymer mixture can be an extreme pH or temperature such as, pH 9.5 to pH 13 or a high temperature of 70° C. to 99° C. as well as urea or other described denaturants.

Further, this invention describes a mechanism for separating biomolecules by capillary electrophoresis with the separation conducted above 25° C. and comprising a capillary whose interior is coated with a dynamic polymer and containing a sieving medium with a polymer concentration of greater than 0.5% (w/w), and a buffer system containing a denaturant and having a total conductivity of greater than about 1.6 mS measured at 26° C. and a means to conduct electrophoresis.

Further, this invention describes a mechanism for separating biomolecules by capillary electrophoresis with the separation conducted above 25° C. and comprising a capillary whose interior is coated with a dynamic polymer and containing a sieving medium and a buffer system having a total conductivity of greater than about 2.2 mS measured at 26° C. and a means to conduct electrophoresis.

Another capillary electrophoresis system for the separation of biomolecules in accordance with this invention can comprise a coating covalently attached to the interior of the capillary and a composition containing a buffer system and a sieving medium with a pore size of less than 1200 angstroms, wherein the composition has a total conductivity of greater than 1.3 mS during the separation of the biomolecules. For example, this system can contain a capillary with a coating covalently attached to its interior, a sieving medium and a buffer system comprising 90-1000 mM Tris, 90-1000 mM TAPS and 0-3.5 mM EDTA or a buffer system comprising 110-1000 mM Tris, 90-1000 mM TAPS and 0-5.5 mM EDTA.

A further capillary electrophoresis system for the separation of biomolecules in accordance to this invention can comprise a capillary containing a composition comprising a buffer system and a non-replaceable sieving medium wherein the composition has a total conductivity of greater than 1.3 or 2.1 or even 2.8 mS during the separation of the biomolecules.

The following description is of the preferred mode of carrying out the invention. This description is made for the purpose of illustrating the general principles of the invention and should not be taken in a limiting sense.

This invention can be used advantageously in conjunction with a capillary electrophoresis system, such as the MegaBACE 1000 DNA sequencing system, [GE/Amersham Bioscience, Sunnyvale Calif.]. The system consists of 96-coated capillaries, which can be filled with a polymer solution using high pressure. All capillaries are individually scanned with a moving optical head, which uses laser light to illuminate all the capillaries and simultaneously detects any emanating fluorescence. The system is designed for electrophoresis so it therefore contains buffer reservoirs, high voltage power supply and the proper mechanical and software configuration for the process, which can be used in accordance with the instructions supplied by the manufacturer of the instrument.

Although this example illustrates the application of the invention for DNA sequencing, it is understood in the field that the invention can be used for electrophoresis of all nucleic acids as well as other biomolecules. For example, the techniques and compositions created herein can be used to determine the sequence of RNA, proteins and polypeptides.

DNA contains four bases [AGCT] that are labeled with fluorescent molecules each with a unique emission color spectrum for each base. The emitting color of each molecule is therefore inextricably linked to a particular base. A length of DNA whose sequence is unknown can be labeled with fluorescent molecules. The process is done in a way that produces a continuum of fragment sizes with the last base in the fragment being the only one fluorescently labeled; this process is the “Sanger Sequencing Reaction”. All the labeled fragments are then electro-kinetically injected into the capillary and separated by fragment size using electrophoresis. If the fragments are clearly separated from each other by size and emit sufficient intensity the software can determine which base [A, G, C or T] is passing through the detector at any moment in time. The software can then assemble the sequence of the unknown DNA and assign a confidence level for the accuracy of each base call in the sequence. The confidence level is determined by an algorithm in the software that relates the following parameters: Resolution, separation and peak height uniformity and signal to noise. A confidence level of 99% accuracy is the usual criteria for sequence data to be considered good quality. Larger fragments progressively have a decrease in signal to noise ratio and a decrease in resolution and therefore a lower confidence value. One of the advantages of this invention is that it increases the confidence values of these larger fragments, which produces an increase in readlength. Thus, this invention uses high conductivity polymer solutions to increase readlength by improving resolution and signal to noise ratio for large fragments.

A polymer solution is the sieving medium used in the MegaBACE 1000 since it facilitates the automation of the capillary refilling process. The capillaries for the MegaBACE 1000 are coated to reduce electro-osmotic flow [EOF], which allows the use of a polymer like linear polyacrylamide (LPA) for sieving. If the capillaries are not coated, a method is needed to suppress EOF. Polymers like dimethylacrylamide [pDMA], polyethylene oxide [PEO] or Hydrolyzed Epoxy Poly Dimethylacrylamide [see U.S. Pat. No. 6,410,668] are dynamic coatings and, unlike polyacrylamide, they do not require a separate coating to reduce EOF. Polyacrylamide can be used as the main sieving medium if a self-coating additive such a pDMA is added in small but sufficient concentrations to suppress EOF.

### EXAMPLE 1

To make a polymer solution, a buffer solution and denaturant were mixed in water at the following concentrations:

| | |
|---|---|
| 175 mM Tris | (Tris[hydroxymethyl]aminomethane) |
| 150 mM TAPS | (N-tris[Hydroxymethyl]methyl-3- |
| | aminopropanesulfonic acid; ([2-Hydroxy-1, |
| | 1-bis(hydroxymethyl)ethyl]amino)-1- |
| | propanesulfonic acid) |
| 6.4 M Urea | (A range of urea concentrations from 4 M to |
| | 8 M can be depending on separation time and |
| | denaturing requirements.) |

Linear polyacrylamide was added to the buffer solution and mixed with a stir bar or overhead stirrer at very low speed. The polymer solution percentage was approximately 2.5% for a polymer approximately 10 million molecular weight. The percentage varies depending on several factors. The viscosity of the mix has to be low enough to facilitate the filling of the capillary in a reasonable time and pressure. In addition, the percentage and molecular weight should be optimized for the best separation for the type and size of fragments used. Standard methods were used to mix and properly handle linear polyacrylamide solutions. See, for example, [16] and U.S. Pat. No.6,554,985.

A second method of preparing a polymer solution was carried out by using the standard solution polymerization method used for slab gels without the cross linker. This method produces a broader range of molecular weights than emulsion polymerization but has been used successfully.

The MegaBACE 1000 requires six 2 ml tubes filled with 0.8 ml of polymer solution. After placing the polymer solution in the tubes, the tubes were sealed with an O-ring cap and placed in a 60° C. temperature bath for 80 minutes directly before use. The tubes were opened and a vacuum [at 29.5 inches of Hg] applied for 2 minutes followed by centrifugation at 4.0 RCF for 3 minutes. This process increases the conductivity of the solution by partial decomposition of the sieving solution and degasses it.

A DNA sequencing sample was prepared following the protocol of the Joint Genome Institutes web site (http//www.jgi.doe.gov, “Production Protocols”) or the protocol suggested by Applied Biosystems [Foster City, Calif., http://www.appliedbiosystems.com] for product no. 4337450 Big Dye Terminator v1.1 cycle sequencing kit. The reaction product was adequately purified by precipitation in ethanol and re-suspension in water [Joint Genome Institute Web site]. A gel spin column [DTR, Edge Biosystems, Gaithersberg, Md. 20879] for reaction clean up [removes dye terminator nucleotides] leaves a substantial amount of salt ions in the final product and should be avoided unless desalted prior to use. If a dye primmer sequencing reaction is used, then Ruiz-Martinez [22] describes more completely the preparation and clean up of DNA primmer sequencing fragments.

Following purification the sample was re-suspended in water or a template suspension solution [as described in U.S. Pat. Nos. 6,051,636 or 6,294,064] and then the analyte was electro-kinetically injected into the capillaries of the MegaBACE 1000. The injection time and voltage affects the magnitude of the signal and the width of the injection plug. A voltage of 2 kV for 30 seconds is a good starting point. The sample concentration will primarily determine whether the injection time is to be increased or decreased. Choosing the shortest time that produces an adequate signal to noise ratio for the larger fragments without excessive peak broadening is the criterion.

The running buffer in the cathode and anode reservoirs was 90 mM Tris, 300 mM, TAPS and 3 mM EDTA at ph7.8. Operating conditions for the run were 44° C., running voltage 6.5 kv and a pre-run of 7 kv for 10 minutes with total running time being about 250 minutes.

### EXAMPLE 2

The same as Example 1 but with the following change: the temperature surrounding the capillary should be 60° C.

### EXAMPLE 3

The same as Example 1 but with the following changes: the buffer solution is Tris=300 mM, TAPS=225 mM, EDTA=1 mM. The polymer solution is not heated for 80 minutes at 60° C.

### EXAMPLE 4

The same as Example 1 but with the following changes: the buffer solution was Tris=80 mM TAPS=240 mM.

### EXAMPLE 5

The same as Example 1 but with the following changes: the buffer solution was Tris=400 mM, Boric Acid=350 mM, EDTA=1 mM in the sieving medium. The running buffer was changed to Tris=400 mM, Boric Acid=350 mM, EDTA=1 mM.

### EXAMPLE 6

The same as Example 1 but with the following changes: Urea=6.4 M becomes Urea=6M plus 10% by weight 2-pyrrolidinone. The capillary separation voltage was increased to 165 volts/cm.

### EXAMPLE 7

The same as Example 1 but with the following changes: Urea=6 M plus formamide 10% by volume. The running voltage is increased to 130 volts/cm.

### EXAMPLE 8

The same as Example 4 but with the following change: Dimethylacrylamide is substituted for LPA [12].

### EXAMPLE 9

The same as Example 1 but with the following change: Dimethylacrylamide is substituted for LPA at 5% concentration and the molecular weight of dimethylacrylamide decreased to around 200,000.

### EXAMPLE 10

The same as Example 8 but with the following change: the buffer is Tris=0 mM, TAPS=250 mM, EDTA=1 mM and is titrated with NaOH until it reaches pH 8.1.,

### EXAMPLE 11

The same as Example 1 but with the following change: the capillary array in the MegaBACE 1000 is uncoated and an instant coating polymer, Hydrolyzed Epoxy Poly Dimethylacrylamide, is used to suppress EOF as described in U.S. Pat. No. 6,410,668. After the coating process is complete, the subsequent process of example 1 is followed.

### EXAMPLE 12

The same as Example 1 but with the following changes: the capillary array in the MegaBACE 1000 is clean and uncoated, and instead of LPA the sieving medium is Hydrolyzed Epoxy Poly Dimethylacrylamide at 2.5% [w/v] is used according to U.S. Pat. No. 6,410,668.

### EXAMPLE 13

The same as Example 1 but with the following changes: 2 mM KCL is added to the polymer solution.

### EXAMPLE 14

The same as Example 1 but with the following changes: the buffer is Tris=330 mM, TAPS=50 mM, EDTA=1 mM and the polymer solution is not heated for 80 minutes at 60° C.

### EXAMPLE 15

The same as Example 4 except that pDMA with a average molecular weight of 300 kDA is mixed with linear polyacrylamide so that an overall concentration of 0.15% w/w is achieved for the pDMA component.

### REFERENCES

1] “Separation of basic proteins by capillary electrophoresis using cross-linked Polyacrylamide-coated capillaries and cationic buffer additives” A. Cifuentes, et al. Journal of Chromatography A. 655 [1993] 63-72
2] “Synthesis and Characterization of Capillary Columns Coated with Glycoside-Bearing Polymer” Marcella Chiari, et al., Analytical Chemistry 1996 68 2731-2736
3] “DNA and Buffers: Are There Any Non-interacting Neutral pH Buffers?” Nancy C. Stellwagen, et al., Analytical BioChemistry 287 167-175 [2000]
4] “Selected buffer systems for moving boundary electrophoresis of gels at various pH values, presented in a simplified manner” Andreas Chrambach and Thomas Jovin Electrophoresis 1983, 4, 190-204
5] “Anomalous conductivity zones in electrophoresis III. Experimental tests of the theory” Michael Spencer, et al., Electrophoresis 1983 4, 46-52
6] “Polymeric matrices for DNA sequencing by capillary electrophoresis” M. N. Albarghouthi and A. E. Barron, Electrophoresis 2000, 21 4096-4111
7] “pK-Matched Running Buffers for Gel Electrophoresis” Qiang Liu, et. al., Analytical Biochemistry 270 112-122 [1999]
8] ‘Spatial and temporal depletion of ions from noncrosslinked denaturing Polyacrylamide in capillary electrophoresis” Daniel Figeys, et al., Electrophoresis 1994, 15, 1512-1517
9] “Stability of capillary gels for automated sequencing of DNA” Harold Swerdlow, et al., Electrophoresis 1992, 13, 475-483
10] “DNA sequencing up to 1300 Bases in two hours by capillary electrophoresis with mixed replaceable linear Polyacrylamide solutions” Haihong Zhou, Art Miller, et al., Analytical Chemistry 2000
11] “Measuring the Translational Difflusion coefficients of Small DNA Molecules by Capillary Electrophoresis” Nancy Stellwagen, et al., Biopolymers vol. 58 390-397 [2001]
12] “Fast DNA sequencing up to 1000 bases by capillary electrophoresis using poly[N,N-dimethylacrylamide] as a separation medium” Liguo Song, et al., Electrophoresis 2001 22 1987-1996
13] “The resolution of DNA fragments in capillary electrophoresis in replaceable agarose gels” Palm A., Hjerten S. Journal of Capillary Electrophoresis 1996 May/June 3 [3] 173-179
14] “Sodium boric acid: a Tris-free, cooler conductive medium for DNA electrophoresis” Jonathan Brody, et al., Bio Techniques 36:214-216 February 2004
15] “Improved single strand DNA sizing accuracy in capillary electrophoresis” Barnett Rosenblum, et. al., PE Applied Biosystems, Nucleic Acid Research 1997, 3925-2929.
16] Karger, Electrophoresis 1998, 19, 242-248
17] “Diffusion, Joule heating, and band broadening in capillary gel electrophoresis of DNA” Gary Slater, P. Mayer, P. Grossman; Electrophoresis 1995, 16, 75-83
18]“Electrophoresis of Composite Molecular Objects. 1. Relation between Friction, Charge, and Ionic Strength in Free Solution”; C. Desruisseaux, D. Long, G. Drouin, and G. W. Slater; Macromolecules 2001, 34,44-52
19] “Experimental and Theoretical Studies of DNA Separations by Capillary Electrophoresis in Entangled Polymer Solutions” Paul D. Grossman and David S. Soane, Biopolymers, Vol. 31, 1221-1228 (1991)
20] Jean-Louis Viovy: “Electrophoresis of DNA and other polyelectrolytes: Physical mechanisms” Review of Modem Physics, vol 72, No 3, July 2000
21] Haihong Zhou PHD Thesis Chemistry Dept Northeastern University, Boston Mass. year 2000/2001
22] Marie Ruiz-Martinez, et al., [Analytical Chemistry 1998, 70, 8, pages 1516-1527]
23] Dieter Schmalzing, et al., Journal of Chromatography A, 652 (1993) 149-159 “Characterization and performance of a neutral hydrophilic coating for the capillary electrophoretic separation of biopolymers”
24]Judit Horvath and Vladislav Doinik: Electrophoresis 2001, 22, 644-655 “Polymer wall coatings for capillary electrophoresis”
25] Christoph Heller; “Finding a universal low-viscosity polymer for DNA separation” Electrophoresis 1998, 19, page 1691
U.S. Pat. No. 6,716,948
U.S. Pat. No. 5,567,292
U.S. Pat. No. 6,355,709
U.S. Pat. No. 6,074,542
U.S. Pat. No. 6,294,064
U.S. Pat. No. 6,554,985
U.S. Pat. No. 6,410,668
U.S. Pat. No. 6,051,636

### EQUIVALENTS

The disclosure of each of the patents, patent applications and publications cited in the specification is hereby incorporated by reference herein in its entirety. Although the invention has been set forth in detail, one skilled in the art will recognized that numerous changes and modifications can be made, and that such changes and modifications may be made without departing from the spirit and scope of the invention.

The present invention is not to be limited in scope by the specific embodiments described herein, which are intended as single illustrations of individual aspects of the invention, and functionally equivalent methods and components are within the scope of the invention. Various modifications of the invention, in addition to those shown and described herein will become apparent to those skilled in the art from the foregoing description and accompanying drawings. Such modifications are intended to fall within the scope of the appended claims.

I claim:

1. A method to separate biomolecules using capillary electrophoresis comprising placing in a capillary a composition having a sieving medium and total conductivity of greater than 1.8 mS measured at a temperature of at least 26° C., adding the biomolecules to the capillary, and carrying out the separation at a temperature above 25° C.

2. The method of claim 1 where the capillary interior has a covalently attached polymer coating which is not polyvinyl alcohol.

3. The method of claim 1 where the capillary interior has a dynamic polymer coating.

4. The method of claim 1 wherein the total conductivity is greater than 2 mS.

5. The method of claim 1 wherein the total conductivity is greater than 3 mS.

6. The method of claim 1 wherein a denaturant is part of the composition.

7. The method according to claim 1 wherein the biomolecule separated is selected from the group consisting of DNA, RNA, proteins or polypeptides.

8. A polymer mixture for separation of biomolecules in a capillary during capillary electrophoresis comprising:
0.5-9% polymer w/w in a solution having an effective pore size of less than 1200 angstroms; and
a buffer solution containing less than 4 mM EDTA,
wherein the polymer mixture has a total conductivity greater than 1.4 mS at a temperature of at least 26° C. during separation in the capillary.

9. The polymer mixture of claim 8 wherein the total conductivity is greater than 1.8 mS at a temperature of at least 26° C. during separation in the capillary.

10. The polymer mixture of claim 8 wherein the total conductivity is greater than 2.4 mS at a temperature of at least 26° C. during separation in the capillary.

11. The polymer mixture of claim 8 containing a denaturant.

12. The polymer mixture of claim 8 wherein the denaturant is an extreme pH or temperature such as, pH 9.5 to pH 13 or high temperature 70° C. to 99° C.

13. The polymer mixture of claim 8 wherein the capillary interior is coated with a coating selected from the group consisting of: polyacrylamide, acryloylaminoethoxyethanol, acryloylaminoethoxyethylglucose, poly-N-acryloylaminopropanol, hydroxymethylcellulose, dextran, acryloyldiethanolamine acrylamide, dimethylacrylamide, Nacryloylaminoethylethanol, N(acryloylaminoethoxy)ethyl-.beta.D.glycopyranoside. Acryloyldiethanolamine, Poly(vinylpyrrolidone), hydroxyalkylcellulose, poly(ethylene glycolmethacrylate), and Poly(ethyleneoxide).

14. A mechanism for separating biomolecules by capillary electrophoresis comprising a capillary having an interior coated by a dynamic polymer and containing a sieving medium and a buffer system having a total conductivity of greater than about 1.6 mS during a separation conducted at above 26° C. and a means to conduct electrophoresis.

15. The mechanism of claim 14 wherein the coating on the capillary interior is selected from a group of polymers consisting of: polyacrylamide, acryloylaminoethoxyethanol, acryloylaminoethoxyethylglucose, poly-N-acryloylaminopropanol, hydroxymethylcellulose, dextran, acryloyldiethanolamine acrylamide, dimethylacrylamide, Nacryloylaminoethylethanol, N(acryloylaminoethoxy)ethyl-.beta.D.glycopyranoside. acryloyldiethanolamine, Poly(vinylpyrrolidone), hydroxyalkylcellulose, poly(ethylene glycolmethacrylate), and Poly(ethyleneoxide).

16. The mechanism of claim 14 wherein the biomolecule separated is selected from the group consisting of DNA, RNA, protein or polypeptides.

17. A capillary electrophoresis system for the separation of biomolecules, the system comprising a capillary containing:
a coating covalently attached to the interior of the capillary; and
a composition comprising a buffer system and a sieving medium with a pore size of less than 1200 angstroms;
wherein the composition has a total conductivity of greater than 1.3 mS during the separation of the biomolecules.

18. A capillary electrophoresis system for the separation of biomolecules, the system comprising a capillary containing:
a composition comprising a buffer system; and
a non-replaceable sieving medium,
wherein the composition has a total conductivity of greater than 1.3 mS during the separation of the biomolecules.

19. The system of claim 18 wherein the composition has a total conductivity of greater than 2.1 mS during the separation of the biomolecules.

20. The system of claim 18 wherein the composition contains a denaturant.

21. The system of claim 18 wherein the biomolecule separated is selected from the group consisting of DNA, RNA, protein or polypeptides.
